(19) United States
(12) Patent Application Publication
(10) Pub. No.: US 2022/0076544 A1
(43) Pub. Date: Mar. 10, 2022

(54) CHECKOUT APPARATUS

(71) Applicant: TOSHIBA TEC KABUSHIKI KAISHA, Tokyo (JP)

(72) Inventors: Yuki Kawaguchi, Tagata Shizuoka (JP); Hidehiro Naito, Mishima Shizuoka (JP); Shinsuke Yajima, Mishima Shizuoka (JP); Daisuke Hattori, Sunto Shizuoka (JP); Masaki Ito, Numazu Shizuoka (JP); Takahiro Saitou, Izunokuni Shizuoka (JP); Kota Suzuki, Izunokuni Shizuoka (JP)

(21) Appl. No.: 17/224,312

(22) Filed: Apr. 7, 2021

(30) Foreign Application Priority Data
Sep. 4, 2020 (JP) 2020-149144

(51) Int. Cl. G07G 1/00; A47F 9/04

(52) U.S. Cl. CPC G07G 1/0045; A47F 9/04; G07G 1/0018

(57) ABSTRACT

A settlement apparatus includes a bagging unit located near a reading unit for bagging merchandise from which the symbol is read, a measuring unit that measures the bagged merchandise, a light emitting unit provided within a field of view of the bagging operator in the bagging unit, determining means for determining whether or not the merchandise read is bagged using data of a weight measured, and light emission control means for controlling the light emitting unit to emit alight in a first form when the merchandise read is determined as being bagged and controlling the light emitting unit to emit a light in a second form when the merchandise read is determined as being not bagged.

### CROSS-REFERENCE TO RELATED APPLICATION

This application is based upon and claims the benefit of priority from Japanese Patent Application No. 2020-149144, filed on Sep. 4, 2020, the entire contents of which are incorporated herein by reference.

### FIELD

Embodiments described herein relate to a checkout apparatus.

### BACKGROUND

In stores such as supermarkets and convenience stores etc., checkout apparatuses (self-service checkout apparatuses) operated by customers themselves as shoppers are used.

In the above described checkout apparatus, a customer him- or herself performs a series of processes relating to a purchase of merchandise including registration of merchandise to be purchased and bagging operation of the merchandise. Specifically, the registration of the merchandise is performed by an information input unit of the checkout apparatus reading a code symbol such as a barcode attached to the merchandise. Then, the customer performs bagging by putting the registered merchandise in a bag.

However, in the checkout apparatus of related art, a flow line from reading to bagging of merchandise is not particularly considered and room for improvement is left in customer-friendliness.

### DESCRIPTION OF THE DRAWINGS

FIG. 1 is a perspective view of an appearance of a checkout apparatus according to an embodiment.

FIG. 2 is a front view showing the appearance of the checkout apparatus.

FIG. 3 is a top view showing the appearance of the checkout apparatus.

FIG. 4 shows an example of a flow line of a user using the checkout apparatus.

FIG. 5 shows an example of a configuration of the checkout apparatus.

### DETAILED DESCRIPTION

A challenge to be solved is to provide a checkout apparatus in which bagging operation of merchandise can be easily performed.

A checkout apparatus of an embodiment includes a receiving table having a receiving surface on an upper surface, a reading unit provided at a far side and closer to one lateral side of the receiving surface and configured to read a code symbol attached to merchandise, and a bag holding unit provided from a near side and the other lateral side of the receiving surface in a direction toward the reading unit and configured to catch and hold a bag for holding the merchandise, wherein the reading unit and the bag holding unit are provided in positions not overlapping when the receiving table is seen from the front.

As below, an embodiment of a checkout apparatus will be explained with reference to the drawings. An embodiment of a self-service checkout apparatus operated by a customer him- or herself will be explained. Any limitation is not imposed by the following embodiment.

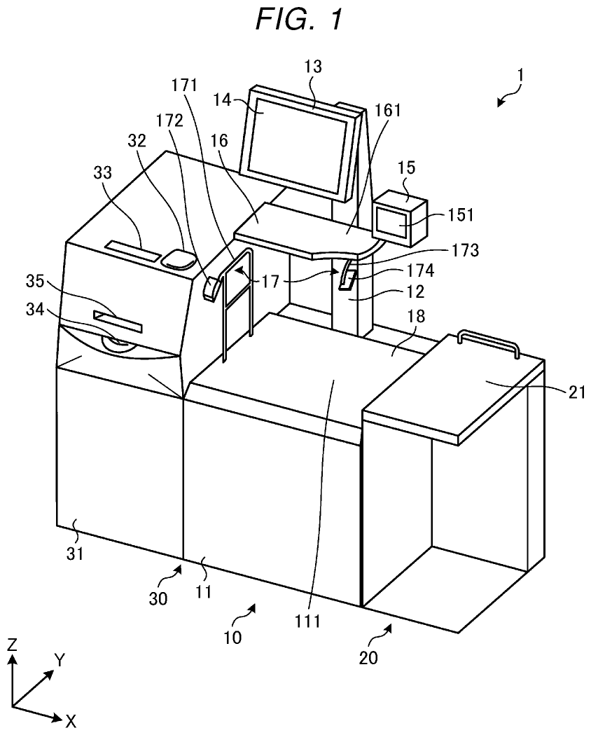

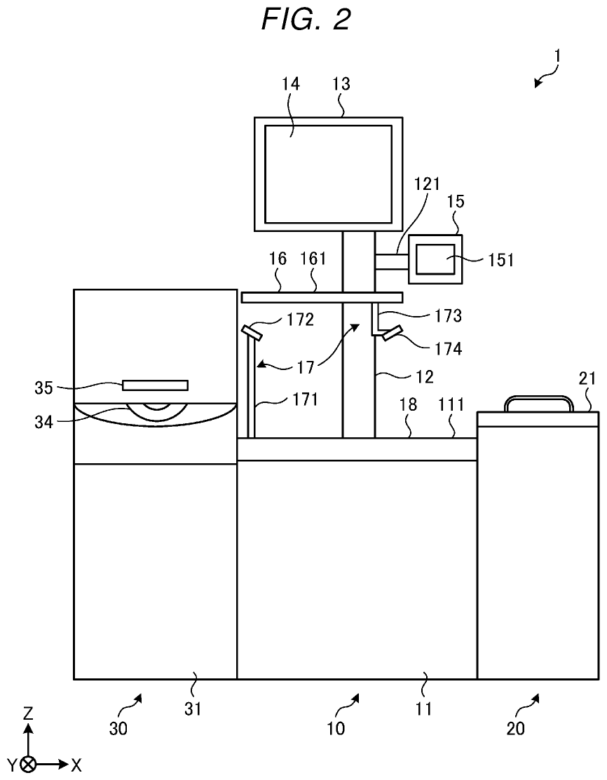

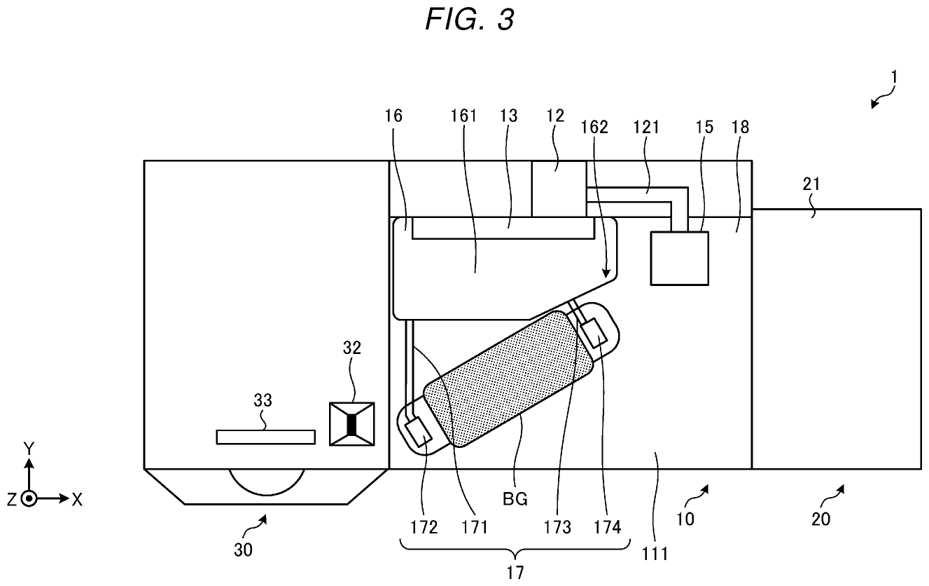

FIG. 1 is a perspective view of an appearance of the checkout apparatus according to the embodiment. FIG. 2 is a front view showing the appearance of the checkout apparatus. FIG. 3 is a top view showing the appearance of the checkout apparatus.

X directions and Y directions shown in the drawings are directions orthogonal to each other and along a horizontal plane. Z directions are vertical directions (height directions) orthogonal to the X directions and the Y directions. Hereinafter, with reference to a registration device 10, the X directions are also referred to as “width directions”, the Y directions are also referred to as “depth directions”, and the Z directions are also referred to as “height directions”. Further, the +Y direction is also referred to as “far side” and the −Y direction is also referred to as “near side”.

As shown in FIG. 1, a self-service checkout apparatus 1 has the registration device 10, a basket stand 20, and a payment device 30.

The basket stand 20 is an example of a placement table. The basket stand 20 is provided adjacent to one lateral side (the right side in the drawing, hereinafter, simply referred to as “right side”) of the registration device 10. The basket stand 20 has a flat placement surface 21 on the top thereof. The merchandise to be purchased by the customer or a basket holding the merchandise is placed on the placement surface 21. The payment device 30 is provided adjacent to the other lateral side (the left side in the drawing, hereinafter, simply referred to as “left side”) of the registration device 10.

In the registration device 10, reading operation (also referred to as “registration operation” and bagging operation of the merchandise placed on the placement surface 21 of the basket stand 20 are performed by the customer. Then, a payment process of the merchandise registered in the registration device 10 is executed in the payment apparatus 30 by the operation of the customer him- or herself.

The registration device 10 includes a box-shaped receiving table 11. The receiving table 11 has a flat receiving surface 111 on the top surface thereof. As will be described later, the flat receiving surface 111 is used as a space for bagging of the registered merchandise or a space for placement of the registered merchandise.

A support 12 is stood at the far side in the depth directions of the receiving surface 111. For example, the support 12 is stood nearly at the center in the width directions of the receiving surface 111 and supports respective parts including a display unit 13, a reading unit 15, and a temporary placement rack 16.

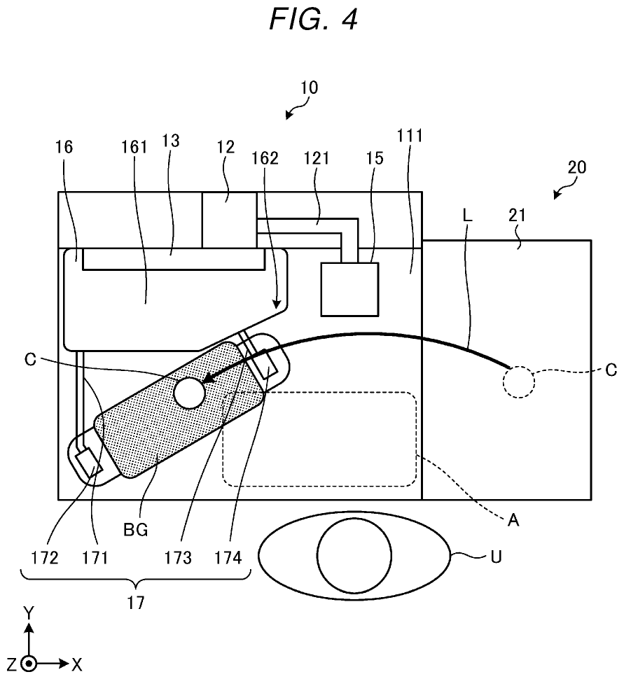

The display unit 13 is attached to an upper portion of the support 12. Here, the height at which the display unit 13 is placed can be arbitrarily designed and, may be a height according to an average height or a height of the face of a user U (see FIG. 4) assumed to use the checkout apparatus 1.

As shown in FIG. 2, the display unit 13 is placed in a position closer to the left side than the substantial center in the width directions of the registration device 10 (receiving table 11), i.e., a position closer to the payment device 30. Further, the display unit 13 is provided in a position farther from a bag holding unit 17, which will be described later, and higher than the bag holding unit 17. Thereby, in the self-service checkout apparatus 1, visibility of the display unit 13 in the bagging operation of merchandise is improved.

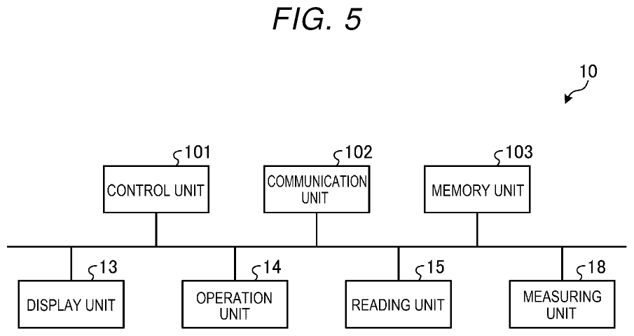

The display unit 13 is a display device such as a liquid crystal display. The display unit 13 displays various kinds of information under control of a control unit 101 (see FIG. 5), which will be described later. Further, a touch panel is provided as an operation unit 14 on a display screen of the display unit 13. The operation unit 14 receives operation on an operator such as an icon displayed on the display unit 13.

The reading unit 15 is placed in a position at the far side and closer to the right side of the receiving surface 111. Specifically, as shown in FIG. 2 or FIG. 3, the reading unit 15 is supported apart from the receiving surface 111 by a supporting member 121 extended rightward from the support 12. Here, the height at which the reading unit 15 is placed can be arbitrarily designed and, is preferably provided in a position nearly equal to or higher than the height of a basket when the basket is placed on the placement surface 21 of the basket stand 20.

Note that, in the embodiment, the reading unit 15 is placed in the position lower than the display unit 13, however, the reading unit 15 and the display unit 13 may be placed side by side in the width directions of the receiving surface 111. Further, in the embodiment, the reading unit 15 is supported by the support 12 (supporting member 121), however, a support for reading unit 15 may be stood from the receiving surface 111. In this case, for example, the support for reading unit 15 is stood at the far side of the receiving surface 111 and between the support 12 and the basket stand 20 and supports the reading unit 15 from underneath.

The reading unit 15 has a reading window 151 and reads a code symbol such as a barcode or two-dimensional code attached to the merchandise. The reading unit 15 may read the code symbol by imaging using an image sensor such as a CCD (Charge Coupled Device) or by irradiating the code symbol with a laser beam and collecting the reflected light.

The code symbol read by the reading unit 15 is decoded by the control unit 101 (see FIG. 5) to be described later, and thereby, a merchandise code of the merchandise with the code symbol attached thereto is extracted. Then, in the control unit 101, a registration process to register the merchandise code as an object of a payment process is executed.

The temporary placement rack 16 is provided between the receiving surface 111 and the display unit 13 in the height directions of the support 12. The temporary placement rack 16 is a plate-like member projecting from the far side toward the near side of the receiving surface 111. The temporary placement rack 16 is supported apart from the receiving surface 111 by the support 12. The temporary placement rack 16 is provided in a position equal to or lower than the reading unit 15, for example, and the lower portion of the temporary placement rack 16 is e.g. a free space in which a basket or the like can be placed.

The temporary placement rack 16 has a flat temporary placement surface 161 on the top surface thereof. The temporary placement rack 16 is used as a rack on which the merchandise is temporarily placed. For example, fragile merchandise such as an egg or tofu is not put into a bag BG immediately after reading of the symbol by the reading unit 15, but placed on the temporary placement rack 16 (temporary placement surface 161) for placement in the upper part of the bag.

Further, the temporary placement rack 16 has a cutoff portion 162 with a corner portion at the reading unit 15 (basket stand 20) side cut off obliquely from the near side on the right toward the far side on the right of the temporary placement rack 16. According to the configuration, in the temporary placement rack 16, when the merchandise read by the reading unit 15 is bagged in the bag BG, interferences with the corner portion of the temporary placement rack 16 may be prevented. Note that the cutoff portion 162 is not necessarily provided.

Further, the registration device 10 includes a bag holding unit 17 for catching and holding a holder that holds merchandise such as a bag or case (hereinafter, simply referred to as “bag BG”). Specifically, the bag holding unit 17 includes a first supporting member 171, a first catching and holding member 172, a second supporting member 173, and a second catching and holding member 174.

The first supporting member 171 is a frame member in a gate shape or a shrine gate shape stood from the receiving surface 111. The first supporting member 171 is provided on the left of the receiving surface 111 from the nearside toward the far side.

The first catching and holding member 172 is a structure for holding (catching and holding) one handle portion of the bag BG and attached to the first supporting member 171. Specifically, the first catching and holding member 172 is attached to an end portion of an upper frame of the first supporting member 171 extended toward the near side of the receiving surface 111 or the like.

The second supporting member 173 is an arm-shaped member attached to the lower surface of the temporary placement rack 16 or the support 12. The second supporting member 173 is projected from the far side on the left of the temporary placement rack 16 toward the near side, specifically, projected toward the near side on the right of the receiving surface 111 and attached. In the embodiment, the second supporting member 173 attached from the position of the cutoff portion 162 of the temporary placement rack 16 toward the near side on the right of the receiving surface 111 is shown.

The second catching and holding member 174 is a structure for holding (catching and holding) the other handle portion of the bag BG and attached to the second supporting member 173. Specifically, the second catching and holding member 174 is attached to an end portion of the second supporting member 173 extended from the temporary placement rack 16.

Note that the distance between the first catching and holding member 172 and the second catching and holding member 174 is not particularly limited, but may preferably be a distance at which a generally used bag such as a plastic bag may be held open.

Here, as shown in FIG. 3, the placement position of the bag holding unit 17 (the first catching and holding member 172 and the second catching and holding member 174) on the receiving surface 111 is provided obliquely from the nearside on the left toward the far side on the right of the receiving surface 111, i.e., toward the reading unit 15. The bag holding unit 17 and the reading unit 15 are provided in the positions not overlapping when the receiving table 11 is seen from the front. Further, the bag holding unit 17 is provided in the position not overlapping with the temporary placement rack 16 when the receiving table 11 is seen from above. According to the configuration, the reading unit 15 and the bag holding unit 17 are located in the positions close to each other in three directions of the width directions, the height directions, and the depth directions of the registration device 10.

The placement angles of the first catching and holding member 172 and the second catching and holding member 174 relative to the X directions in the drawing are provided nearly in parallel toward the near side on the right of the receiving surface 111. Thereby, in the bag holding unit 17, the first catching and holding member 172 and the second catching and holding member 174 can easily catch the handle portions of the bag BG from the near side on the right of the receiving surface 111, i.e., the position facing the reading unit 15.

The first catching and holding member 172 and the second catching and holding member 174 catch the handle portions of the bag BG, and thereby, the bag BG is held open by the bag holding unit 17. Then, the bottom portion of the bag BG held by the bag holding unit 17 comes into contact with the receiving surface 111. Accordingly, the merchandise put into the bag BG is placed on the receiving surface 111 via the bag BG. That is, the weight of the merchandise put into the bag BG is received by the receiving surface 111.

Note that, in the embodiment, the first supporting member 171 is realized using the frame member, however, the member is not limited to the configuration. For example, the first supporting member 171 may be realized using an arm member extended from the lower surface of the temporary placement rack 16 or the support 12 like the second supporting member 173. Further, in the embodiment, the second supporting member 173 is realized using the arm member, however, the member is not limited to the configuration. For example, the second supporting member 173 may be realized using a frame member stood from the receiving surface 111 like the first supporting member 171.

Furthermore, the registration device 10 includes a measuring unit 18. The measuring unit 18 is a scale for measuring the weight of the merchandise provided in the lower part of the receiving surface 111. The measuring unit 18 measures e.g. the weight of the merchandise in the bag BG held by the bag holding unit 17. Or, the measuring unit 18 measures the weight of the merchandise placed on the temporary placement rack 16.

The payment device 30 is a device that performs a payment process (settlement process) of the merchandise registered by the registration device 10. The payment device 30 has a housing 31 having a nearly box shape and includes a change machine (not shown) within the housing 31. The change machine holds bills and coins inside.

The payment device 30 has a coin insertion slot 32 and a bill insertion slot 33 in the upper surface of the housing 31. The coin insertion slot 32 is an insertion portion in which coins of the payment of the deposit as the payment for the purchased merchandise are inserted. The coins inserted from the coin insertion slot 32 are held in the change machine. The bill insertion slot 33 is an insertion portion in which bills of the payment of the deposit as the payment for the purchased merchandise are inserted. The bills inserted from the bill insertion slot 33 are held in the change machine. Note that the payment device 30 may have a configuration for electronic settlement (a card reader or the like), not limited to the configuration for cash settlement.

Further, the payment device 30 has a coin change exit 34 and a bill change exit 35 on the front side of the housing 31. When there is change to be handed to the customer for the money (deposit) inserted from the coin insertion slot 32 or the bill insertion slot 33, the coin change exit 34 exits the coin change ejecting from the change machine. When there is change to be handed to the customer for the deposit, the bill change exit 35 exits the bill change ejecting from the change machine.

Furthermore, the payment device 30 includes a printer (not shown). When the payment process is performed, the printer issues a receipt on which merchandise information of the registered merchandise and the details of the payment process are printed.

Next, referring to FIG. 4, operations by a user when reading of the merchandise is performed in the registration device 10 will be explained. Here, FIG. 4 shows an example of a flow line of the user using the checkout apparatus (registration device 10). In FIG. 4, the registration device 10 and the basket stand 20 are shown as seen from above.

First, a user U using the self-service checkout apparatus 1 places a basket (not shown) with merchandise C to be purchased inside on the placement surface 21 of the basket stand 20. Then, the user U takes the merchandise C out of the basket placed on the basket stand 20 and moves the merchandise C to the position of the reading window 151 of the reading unit 15, and thereby, performs reading operation by the reading unit 15 reading a code symbol attached to the merchandise C. In this regard, the user U performs the reading operation in a position right in front of the reading unit 15, and may efficiently perform reading of the merchandise C for the reading unit 15. After reading of the merchandise C is completed, the user U performs bagging operation to move the merchandise C from the position of the reading window 151 into the bag BG held by the bag holding unit 17.

In the above described series of operations relating to the reading operation and the bagging operation, a trajectory (flow line) of the movement of the merchandise C is an arc-shaped flow line L as shown in FIG. 4.

As described above, in the self-service checkout apparatus 1, the reading unit 15 is provided in a position closer to one lateral side (right side) of the reading unit 15 and the basket stand 20 is adjacently placed at the lateral side at which the reading unit 15 is provided. Accordingly, in the self-service checkout apparatus 1, the flow line from the basket stand 20 to the reading unit 15 may be shortened.

Further, in the self-service checkout apparatus 1, the reading unit 15 and the bag BG (bag holding unit 17) as seen from the front of the registration device 10, i.e., from the user U are in a close position relationship in three directions of the width directions, the height directions, and the depth directions of the registration device 10. Furthermore, in the self-service checkout apparatus 1, the reading unit 15 is located at the far side and the bag BG is located at the near side and the reading unit 15 is located in the position higher than the position in which the bag BG is held by the bag holding unit 17.

Thereby, the user U may easily put the merchandise C carried to the position of the reading unit 15 in the position right in front of the reading unit 15 into the bag BG. Further, the user may move the merchandise C carried to the position of the reading unit 15 to the position of the bag BG by moving the merchandise leftward while pulling the merchandise toward the near side, and thereby, may perform bagging of the merchandise C in a natural action. The reading unit 15 is located in the position higher than the position in which the bag BG is held by the bag holding unit 17 and bagging of the merchandise C may be performed by dropping of the merchandise from the reading unit 15, and thereby, operability for bagging of the merchandise C may be improved.

Therefore, in the self-service checkout apparatus 1, transition from the reading operation to the bagging operation may be smoothly performed and the bagging operation of the merchandise C may be easily performed.

Further, in the self-service checkout apparatus 1, the bag BG is held with a tilt by the bag holding unit 17 from the near side on the left to the far side on the right of the receiving surface 111. According to the configuration, the opening portion of the bag BG held by the bag holding unit 17 is nearly right in front of the user U when the merchandise C is moved from the reading unit 15 to the bag BG. Therefore, in the self-service checkout apparatus 1, the operability for bagging of the merchandise C may be improved and the bagging operation of the merchandise C may be easily performed.

Furthermore, in the self-service checkout apparatus 1, as described above, the bag BG is held from the near side on the left to the far side on the right of the receiving surface 111, and an area A at the near side on the right of the receiving surface 111, i.e., the area at the near side of the reading unit 15 is free. Therefore, in the self-service checkout apparatus 1, the area A may be used in the same manner as the temporary placement rack 16 and the bagging operation of the merchandise C may be efficiently performed.

In the self-service checkout apparatus 1, when the bag BG (bag holding unit 17) is seen from the position of the user U, the display unit 13 is located on the back of the bag BG. According to the configuration, the user U can easily check the window displayed on the display unit 13 while performing the bagging operation of the merchandise C. Therefore, in the self-service checkout apparatus 1, convenience for the bagging operation of the merchandise may be improved.

Note that the control unit 101 to be described later controls the display unit 13 to display information on the registered merchandise via the reading unit 15. Further, after the registration of the merchandise is completed, the control unit 101 to be described later controls the display unit 13 to display a total amount of the registered merchandise or the like and display an operation window for the payment process. The user performs the reading operation and the bagging operation on all merchandise, and then, moves to the payment device 30 for payment of the merchandise and performs operation of paying money or the like.

Here, in the self-service checkout apparatus 1, the display unit 13 is provided in the position closer to the payment device 30, and thereby, the user may proceed with the operation while viewing the windows displayed on the same display unit 13 from the reading operation to the payment process. Therefore, in the self-service checkout apparatus 1, the series of processes (reading, bagging, settlement) relating to the purchase of merchandise may be efficiently performed.

As below, a hardware configuration of the registration device 10 will be explained. FIG. 5 shows an example of the hardware configuration of the registration device 10.

As shown in FIG. 5, the registration device 10 includes the control unit 101, a communication unit 102, and a memory unit 103 in addition to the above described display unit 13, operation unit 14, reading unit 15, and measuring unit 18.

The control unit 101 has a computer configuration including a processor such as a CPU (Central Processing Unit), a ROM (Read Only Memory), and a RAM (Random Access Memory). The respective parts of the registration device 10 are connected to the control unit 101 via a bus, an input and output controller, or the like.

The communication unit 102 is an interface for communication with an external device including the payment device 30. The control unit 101 transmits and receives data with the payment device 30 and the like via the communication unit 102 and transmits and receives data with an external device including a store server.

The memory unit 103 includes an HDD (Hard Disk Drive) or a non-volatile memory such as a flash memory. The memory unit 103 stores various programs and setting information executed by the processor of the control unit 101. Further, the memory unit 103 may store a merchandise master in which merchandise information including names, prices, weights of merchandise items are stored in correlation to merchandise codes for identification of the respective merchandise items. Note that the weights are desirably stored in certain acceptable ranges in consideration of variations in weights of the individual merchandise items, variations in weights due to measurement environments, or the like.

In the above described configuration, the control unit 101 executes various kinds of control on the merchandise registration and the payment process in cooperation with the programs stored in the memory unit 103.

For example, when the code symbol is read via the reading unit 15, the control unit 101 decodes the code symbol and extracts the merchandise code. Further, the control unit 101 reads the merchandise information corresponding to the extracted merchandise code from the merchandise master. Furthermore, the control unit 101 determines whether or not the merchandise read by the reading unit 15 is bagged based on the measurement data measured by the measuring unit 18.

Specifically, the control unit 101 compares the measurement data measured by the measuring unit 18 with the data of the weight of the merchandise stored in the merchandise information with respect to the merchandise read by the reading unit 15. Here, when the weights are the same (or nearly the same), the control unit 101 determines that the merchandise read by the reading unit 15 is the merchandise placed in the bag, and registers the merchandise code of the merchandise as merchandise to be paid. Further, the control unit 101 controls the display unit 13 to display information on the registered merchandise (name, price, etc.)

On the other hand, when the weights are not the same, the control unit 101 determines that the merchandise read by the reading unit 15 is not the merchandise placed in the bag. In this case, the control unit 101 may control the display unit 13 to display a window prompting placement of the merchandise into the bag BG.

Then, when receiving operation to indicate the completion of the registrations of all merchandise items via the operation unit 14, the control unit 101 calculates the total amount of the registered merchandise items and controls the display unit 13 to display a window prompting payment of the total amount in the payment device 30. Note that the control unit 101 may control the display unit 13 to display an operator for selection of cash settlement or electronic settlement.

Then, when receiving the payment of the total amount from the payment device 30, the control unit 101 controls the display unit 13 to display a window reporting completion of the payment process and ends a process for single transaction.

The above described embodiments can be appropriately modified and implemented by partial changes made to the configurations or the functions of the above described self-service checkout apparatus 1. Accordingly, as below, several modified examples according to the above described embodiments will be explained as other embodiments. Note that the differences from the above described embodiments will be mainly explained and the detailed explanation of the parts in common with the above description will be omitted. Further, the modified examples to be described later may be individually implemented or appropriately combined and implemented.

### Modified Example 1

In the above described embodiments, the basket stand 20 is provided on the right of the registration device 10 and the payment device 30 is provided on the left of the registration device 10, however, the basket stand 20 and the payment device 30 may be exchanged. Note that, in this case, the respective parts of the registration device 10 may be placed in a left-right reversal arrangement. Specifically, the reading unit 15 is provided closer to the side at which the basket stand 20 is placed and the placement positions of the display unit 13, the temporary placement rack 16, and the bag holding unit 17 are defined with reference to the placement position of the reading unit 15. Thereby, the same functions as those of the above described embodiments may be implemented.

### Modified Example 2

In the above described embodiments, the basket stand 20 is provided adjacent to one lateral side of the registration device 10. However, in place of the basket stand 20, a shopping cart or the like may be placed alongside. Even in the configuration, the shopping cart is placed alongside the side wall side of the registration device 10 at which the reading unit 15 is placed, and thereby, the same functions as those of the above described embodiments may be implemented.

### Modified Example 3

In the above described embodiments, the temporary placement rack 16 is provided, however, the temporary placement rack 16 is not necessarily provided. Further, in the above described embodiments, the cutoff portion 162 is provided in the temporary placement rack 16, however, the temporary placement rack 16 without the cutoff portion 162 may be used.

For example, in the configuration of the embodiment, as shown in FIG. 4, the area A at the near side of the user U may be secured to be wider, and the merchandise placed on the temporary placement rack 16 may be placed in the area A. Thereby, the configuration on the receiving surface 111 may be simplified and the operability may be improved.

### Modified Example 4

In the above described embodiments, the self-service checkout apparatus operated by the customer him- or herself is explained as an example, however, the embodiments may be applied to a checkout apparatus operated by a store clerk.

While certain embodiments have been described, these embodiments are presented as examples, but not intended to limit the scope of the invention. These novel embodiments may be implemented in other various forms and various omissions, replacements, changes may be made without departing from the scope of the invention. These embodiments or their modifications are within the scope of the invention and within the scope of the invention described in claims and equivalents thereof.

What is claimed is:

1. A checkout apparatus, comprising:
a receiving table having a receiving surface on an upper surface;
a reading component provided at a far side and closer to one lateral side of the receiving surface and configured to read a code symbol attached to merchandise; and
a bag holding component provided at a near side and on an opposite lateral side of the receiving surface in a direction toward the reading component and configured to catch and hold a bag for holding the merchandise,
wherein the reading component and the bag holding component are provided in positions not overlapping when the receiving table is viewed from the front.

2. The checkout apparatus according to claim 1, wherein the reading component is provided in a position higher than the bag holding component.

3. The checkout apparatus according to claim 1, further comprising:
a support stoop at the far side of the receiving surface; and
a display provided above the support,
wherein the display is provided in a position at a far side of the bag holding component and higher than the bag holding component.

4. The checkout apparatus according to claim 3, further comprising:
a temporary placement rack configured to temporarily hold the merchandise between the receiving surface and the display in a height direction of the support,
wherein the bag holding component is provided in a position not overlapping with the temporary placement rack when the receiving table is viewed from above.

5. The checkout apparatus according to claim 3, wherein the display comprises a touch panel to input information.

6. The checkout apparatus according to claim 1, further comprising:
a placement table provided adjacent to the one lateral side of the receiving table for placement of the merchandise to be read by the reading component; and
a payment device provided adjacent to the opposite lateral side of the receiving table and configured to execute a payment process of the merchandise after completion of reading by the reading component.

7. The checkout apparatus according to claim 1, wherein the code symbol is a barcode or a two dimensional code.

8. A checkout method, comprising:
reading a code symbol attached to merchandise using a reading component provided at a far side and closer to one lateral side of a receiving surface of a receiving table; and
catching and holding a bag for holding the merchandise using a bag holding component provided at a near side and on an opposite lateral side of the receiving surface in a direction toward the reading component,
wherein the reading component and the bag holding component are provided in positions not overlapping when the receiving table is viewed from the front.

9. The checkout method according to claim 8, wherein the reading component is provided in a position higher than the bag holding component.

10. The checkout method according to claim 8, wherein
a support stoop at the far side of the receiving surface; and
a display provided above the support,
wherein the display is provided in a position at a far side of the bag holding component and higher than the bag holding component.

11. The checkout method according to claim 10, further comprising:
temporarily holding the merchandise between the receiving surface and the display in a height direction of the support using a temporary placement rack,
wherein the bag holding component is provided in a position not overlapping with the temporary placement rack when the receiving table is viewed from above.

12. The checkout method according to claim 10, wherein the display comprises a touch panel to input information.

13. The checkout method according to claim 8, further comprising:
placing of the merchandise to be read by the reading component on a placement table provided adjacent to the one lateral side of the receiving table; and
executing a payment process of the merchandise after completion of reading by the reading component using a payment device provided adjacent to the opposite lateral side of the receiving table.

14. A self service checkout apparatus, comprising:
a payment device;
a receiving table having a receiving surface on an upper surface;
a reading component provided at a far side and closer to one lateral side of the receiving surface and configured to read a code symbol attached to merchandise; and
a bag holding component provided at a near side and on an opposite lateral side of the receiving surface in a direction toward the reading component and configured to catch and hold a bag for holding the merchandise,
wherein the reading component and the bag holding component are provided in positions not overlapping when the receiving table is viewed from the front.

15. The self service checkout apparatus according to claim 14, wherein the reading component is provided in a position higher than the bag holding component.

16. The self service checkout apparatus according to claim 14, further comprising:
a support stoop at the far side of the receiving surface; and
a display provided above the support,
wherein the display is provided in a position at a far side of the bag holding component and higher than the bag holding component.

17. The self service checkout apparatus according to claim 16, further comprising:
a temporary placement rack configured to temporarily hold the merchandise between the receiving surface and the display in a height direction of the support,
wherein the bag holding component is provided in a position not overlapping with the temporary placement rack when the receiving table is viewed from above.

18. The self service checkout apparatus according to claim 16, wherein the display comprises a touch panel to input information.

19. The self service checkout apparatus according to claim 14, further comprising:
a placement table provided adjacent to the one lateral side of the receiving table for placement of the merchandise to be read by the reading component; and
the payment device provided adjacent to the opposite lateral side of the receiving table and configured to execute a payment process of the merchandise after completion of reading by the reading component.

20. The self service checkout apparatus according to claim 14, wherein the code symbol is a barcode or a two dimensional code.
